(19) United States
(12) Patent Application Publication
(10) Pub. No.: US 2025/0363609 A1
(43) Pub. Date: Nov. 27, 2025

(54) VISIBILITY DETERMINING SYSTEM, VISIBILITY DETERMINING METHOD, AND PROGRAM

(71) Applicant: KABUSHIKI KAISHA TOKAI RIKA DENKI SEISAKUSHO, Aichi (JP)

(72) Inventor: Naoki SUNAGAWA, Aichi (JP)

(73) Assignee: KABUSHIKI KAISHA TOKAI RIKA DENKI SEISAKUSHO, Aichi (JP)

(21) Appl. No.: 18/994,284

(22) PCT Filed: Aug. 4, 2023
(86) PCT No.: PCT/JP2023/028585

§ 371 Date: Jan. 14, 2025

(30) Foreign Application Priority Data
Aug. 10, 2022 (JP) 2022-128104

(51) Int. Cl. G06T 7/00; B60K 35/22; G06V 10/56; G06V 10/60; G06V 10/766; G06V 20/59

(52) U.S. Cl. CPC G06T 7/0002; G06V 10/56; G06V 10/60; G06V 10/766; G06V 20/59; B60K 35/22; G06T 2207/30168; G06T 2207/30268; G06V 2201/02

(57) ABSTRACT

A visual recognition determination system is configured to determine visual recognition of a display subject when light is emitted from a light source onto a back surface of a panel, in which the display subject is formed. The light transmitted through the display subject shows the display subject on a pattern on the panel. The pattern serves as a background of the display subject. The visual recognition determination system includes a determination unit that determines the visual recognition of the display subject based on a feature representing a clarity of the pattern on the panel.

### TECHNICAL FIELD

The present disclosure relates to a visual recognition determination system, a visual recognition determination method, and a program.

### BACKGROUND ART

Patent Literature 1 discloses a typical automobile instrument panel that shows a display symbol of an instrument with light from a light source. Such an automobile instrument panel corrects the characteristics of the light emitted onto the display symbol in accordance with the degree of dimming of the light from the light source to ensure the visual recognition of the display symbol.

### CITATION LIST

### Patent Literature

Patent Literature 1: Japanese Laid-Open Patent Publication No. 2004-271258

### SUMMARY OF INVENTION

### Technical Problem

From the aspect of design, studies are being conducted to develop a display device that shows a display symbol on a patterned background by emitting light of a light source from a back surface side of a panel having the patterned background. However, for example, when the pattern on the background is overly dark, the contour of the display symbol may not be recognized. That is, the visual recognition of the display symbol may be insufficient. Accordingly, there is a need for developing a technique that determines the manner in which the display pattern is shown taking into consideration the pattern on the background.

### Solution to Problem

In one general aspect, a visual recognition determination system is configured to determine visual recognition of a display subject when light is emitted from a light source onto a back surface of a panel, in which the display subject is formed, and the light transmitted through the display subject shows the display subject on a pattern on the panel, the pattern serving as a background of the display subject. The visual recognition determination system includes a determination unit that determines the visual recognition of the display subject based on a feature representing a clarity of the pattern on the panel.

In another general aspect, a method is for determining visual recognition used in a visual recognition determination system. The visual recognition determination system is configured to determine visual recognition of a display subject when light is emitted from a light source onto a back surface of a panel, in which the display subject is formed, and the light transmitted through the display subject shows the display subject on a pattern on the panel, the pattern serving as a background of the display subject. The method includes obtaining, by the visual recognition determination system, a feature that represents a clarity of a pattern on the panel; and determining, by the visual recognition determination system, the visual recognition of the display based on the feature representing the clarity of the pattern on the panel.

In another general aspect, a program is used in a visual recognition determination system. The visual recognition determination system is configured to determine visual recognition of a display subject when light is emitted from a light source onto a back surface of a panel, in which the display subject is formed, and the light transmitted through the display subject shows the display subject on a pattern on the panel, the pattern serving as a background of the display subject. The program causes a computer to execute obtaining a feature that represents a clarity of a pattern on the panel, and determining the visual recognition of the display based on the feature representing the clarity of the pattern on the panel.

### Advantageous Effects of Invention

A general aspect of the present disclosure accurately determines the visual recognition of the display subject.

### BRIEF DESCRIPTION OF DRAWINGS

FIG. 1A is a front view of a panel in accordance with a first embodiment when a display subject is illuminated. FIG. 1B is a front view of the panel when the display subject is not illuminated.

FIG. 2 is a diagram showing the structure of a display device in which the panel is shown in cross section.

FIG. 3 is a diagram showing an example of a brightness histogram when a pattern is clear.

FIG. 4 is a diagram showing an example of a brightness histogram when the pattern is unclear.

FIG. 5 is a diagram illustrating a method for obtaining a mark visual angle.

FIG. 6 is a diagram illustrating a method for obtaining a difference in chromaticity between the panel and a display subject.

FIG. 7 is a diagram showing the configuration of a visual recognition determination system.

FIG. 8 is a diagram showing the configuration of a visual recognition determination system in accordance with a second embodiment.

FIG. 9 is a diagram showing the configuration of a visual recognition determination system in accordance with a third embodiment.

FIG. 10 is a diagram illustrating operation of the visual recognition determination system.

FIG. 11 is a schematic diagram showing a notification example of a result of a visual recognition determination.

### DESCRIPTION OF EMBODIMENTS

### First Embodiment

A first embodiment of the present disclosure will now be described.

### Overview of Display Device 1

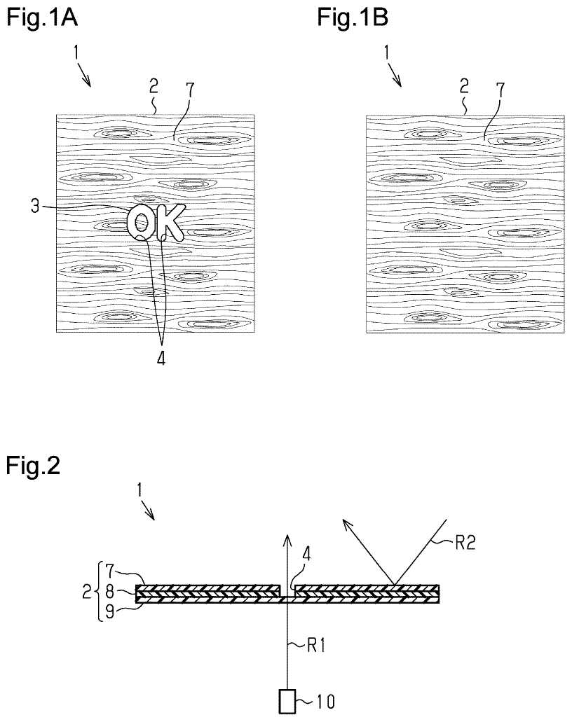

As shown in FIG. 1A, a display device 1 includes a patterned panel 2, and a display subject 3 formed in the panel 2. The display device 1 shows the display subject 3 on the background of the patterned panel 2 by lighting. The panel 2 has, for example, a wood-grain pattern. The display subject 3 is, for example, defined by an opening 4 formed in the panel 2. When the display subject 3 is not illuminated, the display subject 3 is not visible (refer to FIG. 1B). When the display subject 3 is illuminated, the display subject 3 is shown on the panel 2 (refer to FIG. 1A). Examples of the display subject 3 include, for example, a symbol, a character, a number, an illustration, or the like.

As shown in FIG. 2, the panel 2 includes a patterned front surface layer 7, a black printed layer 8 arranged on a back surface of the front surface layer 7, and a transparent plate 9 arranged on a back surface of the printed layer 8. The front surface layer 7 is, for example, a resin layer having a wood-grain pattern. The printed layer 8 is, for example, a colored resin layer (or may be light-blocking plate). The transparent plate 9 is arranged, for example, over the entire back surface of the printed layer 8. The opening 4, which defines the shape of the display subject 3, extends through both the front surface layer 7 and the printed layer 8. For example, the opening 4 may be hollow or filled with a transparent (translucent) material.

The display device 1 includes a light source 10 that irradiates the display subject 3 from a back surface side of the panel 2. The light source 10 is, for example, a light-emitting diode (LED). There may be one or more light sources 10. The display device 1 emits light (illumination light R1) of the light source 10, which is arranged at the back surface side of the panel 2, through the opening 4 in the panel 2 and illuminates the display subject 3 on the background of the patterned panel 2. A user visually recognizes the illumination light R1 transmitted through the display subject 3 as the display subject 3. The user also receives sunlight R2 reflected by the panel 2.

The display device 1 is, for example, mounted on a vehicle. In this case, the display device 1 is arranged in, for example, a center cluster, a center console, a steering wheel, or the like. The display device 1 shows, for example, an operation icon of an in-vehicle device as the display subject 3. The operation icon is, for example, an icon for selecting or determining an operational state of the in-vehicle device. For example, when a vehicle power supply is activated, the display device 1 drives the light source 10 and shows the display subject 3 on the panel 2.

### Factor Affecting Visual Recognition of Display Subject 3

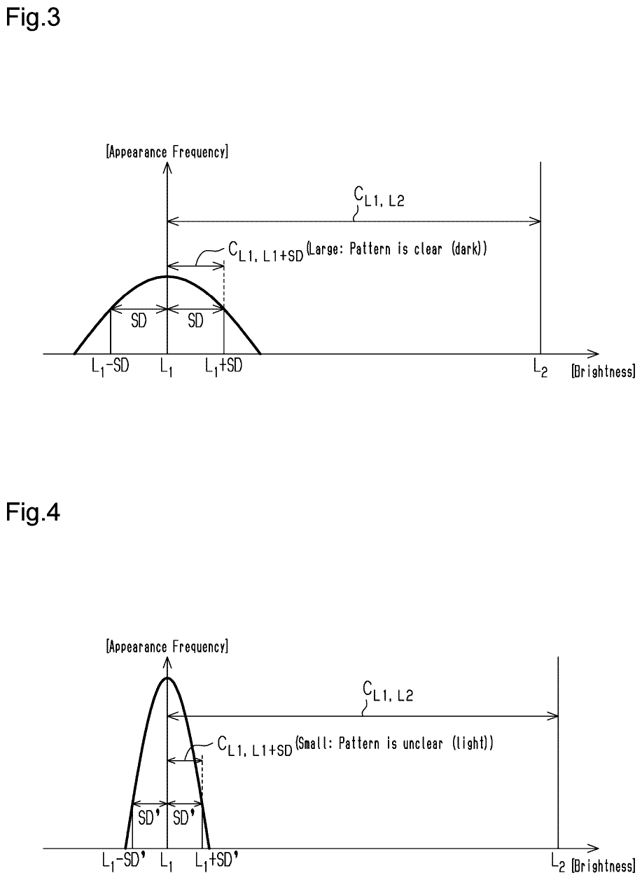

As shown in FIGS. 3 and 4, a factor affecting the visual recognition of the display subject 3 includes, for example, a clarity C_{L1, L1+SD} of the pattern on the panel 2. Design elements related to the clarity C_{L1, L1+SD} of the pattern on the panel 2 include, for example, the design of the panel 2, the reflectance of the panel 2, or the like. For example, when the pattern is overly dark, the clarity C_{L1, L1+SD} of the panel 2 is reduced. This adversely affects the visual recognition of the display subject 3.

A factor affecting the visual recognition of the display subject 3 includes, for example, a clarity C_{L1, L2} of the display subject 3. Design elements related to the clarity C_{L1, L2} of the display subject 3 include, for example, the brightness of the display subject 3 produced by the light source 10, the transmittance of the display subject 3, the reflectance of the panel 2, or the like. For example, when a difference in brightness between the panel 2 and the display subject 3 is relatively small, the clarity C_{L1, L2} of the display subject 3 is reduced. This adversely affects the visual recognition of the display subject 3.

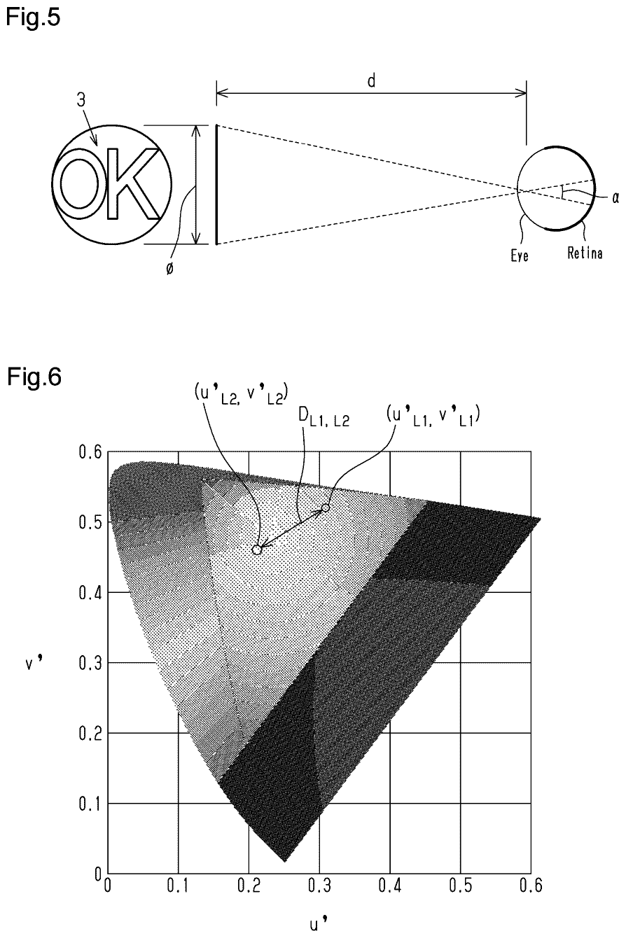

As shown in FIG. 5, a factor affecting the visual recognition of the display subject 3 includes, for example, a mark visual angle α representing the size of the display subject 3. Design elements related to the mark visual angle α include, for example, the size of the display subject 3, the arrangement location of the display subject 3, an eye point, or the like. For example, when the size of the display subject 3 is relatively small, the mark visual angle α is reduced. This adversely affects the visual recognition of the display subject 3.

As shown in FIG. 6, a factor affecting the visual recognition of the display subject 3 includes, for example, a chromaticity difference D_{L1, L2} between the panel 2 and the display subject 3. Design elements related to the chromaticity difference D_{L1, L2} between the panel 2 and the display subject include, for example, the color of the light source of the display subject 3, the transmission characteristics of the display subject 3, the design of the panel 2, or the like. The transmission characteristics of the display subject 3 include, for example, whether the display subject 3 changes the color shown on the panel 2. For example, when the color of the panel 2 is relatively close to the color of the display subject 3, the chromaticity difference D_{L1, L2} is reduced. This adversely affects the visual recognition of the display subject 3.

Although not shown in the drawings, a factor affecting the visual recognition of the display subject 3 may also include, for example, a similarity between the pattern on the panel 2 and the shape of the display subject 3. Design elements related to the similarity between the pattern on the panel 2 and the shape of the display subject 3 include, for example, the design of the panel 2 or the like. For example, when the pattern on the panel 2 is similar to the shape of the display subject 3, it is difficult to distinguish the panel 2 and the display subject 3 from one another. This adversely affects the visual recognition of the display subject 3.

### Overview of Visual Recognition Determination System 13

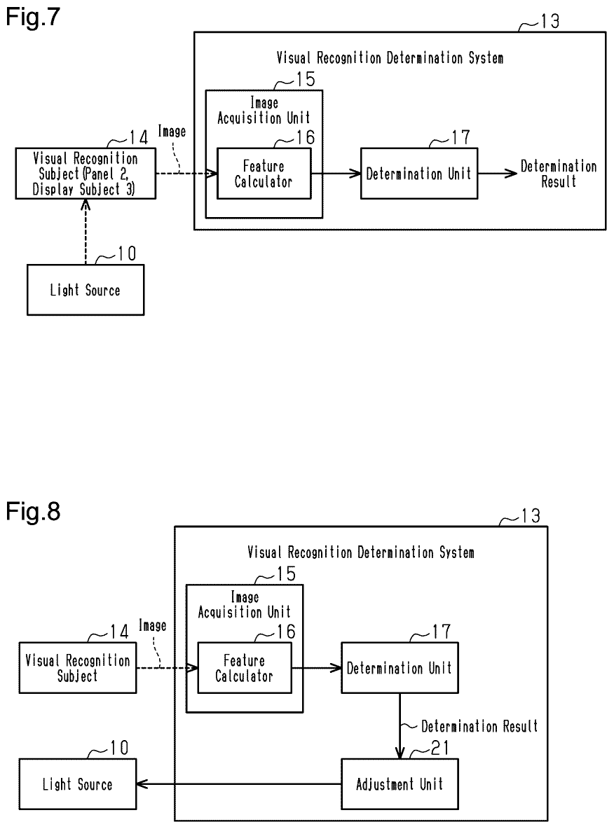

As shown in FIG. 7, a visual recognition determination system 13 determines the visual recognition of the display subject 3 shown by the display device 1. When determining the visual recognition of the display subject 3, for example, the ease in visually recognizing the display subject 3 shown on the patterned panel 2 is determined. For example, the visual recognition determination system 13 may execute the visual recognition determination constantly or when an initiation operation of the visual recognition determination is performed.

The visual recognition determination system 13 includes an image acquisition unit 15 that obtains an image of a visual recognition subject 14. The image acquisition unit 15 is, for example, an optical device that obtains an image based on the characteristics of light. The optical device includes, for example, a luminance meter. The image acquisition unit 15 obtains, for example, an image of the panel 2 (including display subject 3) as the visual recognition subject 14. Thus, the visual recognition subject 14 corresponds to, for example, the panel 2 including the display subject 3.

The visual recognition determination system 13 includes a feature calculator 16 that calculates a feature used for the visual recognition determination of the display subject 3. In the present example, the feature calculator 16 is arranged in, for example, the image acquisition unit 15. For example, the feature calculator 16 uses a captured image to calculate features, such as the clarity C_{L1, L1+SD} of the pattern on the panel 2, the clarity C_{L1, L2} of the display subject 3, the mark visual angle α, the chromaticity difference D_{L1, L2}, or the like.

The visual recognition determination system 13 includes a determination unit 17 that determines the visual recognition of the display subject 3 based on the feature representing the clarity C_{L1, L1+SD} of the pattern on the panel 2. In the present example, the determination unit 17 determines the visual recognition of the display subject 3 using, in addition to the clarity C_{L1, L1+SD} of the pattern on the panel 2, at least one of the clarity C_{L1, L2} of the display subject 3, the mark visual angle α, and the chromaticity difference D_{L1, L2} of the panel 2 and the display subject 3.

### Visual Recognition Determination Method

The visual recognition determination system 13 performs a visual recognition determination, for example, at an actual attachment counterpart of the display device 1. More specifically, the visual recognition determination system 13 determines the visual recognition of the display subject 3 based on an image (image data) showing the panel 2 and the display subject 3 in the display device 1 that is mounted on an actual vehicle.

As shown in FIG. 7, the feature calculator 16 calculates the features used for the visual recognition determination from an image obtained by the image acquisition unit 15. In an example, the feature calculator 16 calculates, based on the image obtained by the image acquisition unit 15, the clarity C_{L1, L1+SD} of the pattern on the panel 2, the clarity C_{L1, L2} of the display subject 3, the mark visual angle α (degree), and the chromaticity difference D_{L1, L2} between the panel 2 and the display subject 3.

After calculating these features, the determination unit 17 uses the following determination equation (1) to determine the visual recognition of the display subject 3.

$$Expressio n 1$$

$$p = \frac{1}{1 + exp \{ - ( {k}_{0} + {k}_{1} {C}_{L 1 , L 2} + {k}_{2} {C}_{L 1 , L 1 + SD} + {k}_{3} {D}_{L 1 , L 2} + {k}_{4} α ) \}} \qquad ( 1 )$$

As indicated above, the determination unit 17 substitutes the features representing the clarity C_{L1, L1+SD} of the pattern on the panel 2 and the like into the determination equation (1) for determining the visual recognition of the display subject 3 to obtain a determination value p. Then, the determination unit 17 determines the visual recognition of the display subject 3 based on the determination value p. In the present example, the determination value p is calculated using the features representing the clarity C_{L1, L1+SD} of the pattern on the panel 2, the clarity C_{L1, L2} of the display subject 3, the mark visual angle α, and the chromaticity difference D_{L1, L2}. The determination equation (1) is an equation that uses logistic regression analysis for predicting whether the visual recognition will be satisfactory through regression analysis of multiple explanatory variables.

The determination value p is, for example, a single value within a range of 0 to 1 (0≤p≤1). When the determination value p is greater than or equal to a specified value, it may be determined that the visual recognition of the display subject 3 is satisfactory. Further, when the determination value p is less than the specified value, it may be determined that the visual recognition of the display subject 3 may be improved. In equation (1), “k₀” is a constant term. Further, “k₁”, “k₂”, “k₃”, and “k₄” in equation (1) are coefficients. These constant term and coefficients may be set in accordance with, for example, a visual recognition determination standard.

### Calculation of Clarity C_{L1, L1+SD} of Pattern on Panel 2

As shown in FIGS. 3 and 4, when obtaining the clarity C_{L1, L1+SD} of the pattern on the panel 2, the feature calculator 16 uses an average brightness L₁ (cd/m²) of the panel 2 and a standard deviation SD of the brightness (cd/m²) of the panel 2. Then, the determination unit 17 calculates the clarity C_{L1, L1+SD} of the pattern on the panel 2 by the following equation (2). The standard deviation SD represents deviations of the brightness of the panel 2 in a histogram, that is, a degree of variation in a brightness distribution of the panel 2.

$$Equation 2$$

$${C}_{L 1 , L 1 + SD} = \frac{( {L}_{1} + SD ) - {L}_{1}}{{L}_{1}} = \frac{SD}{{L}_{1}} \qquad ( 2 )$$

As indicated above, the clarity C_{L1, L1+SD} of the pattern on the panel 2 is a value indicating a brightness difference between a ratio of “L₁” to “L₁” and a ratio of “L₁+SD” to “L₁”, that is, a ratio of “SD” to “L₁”. The clarity C_{L1, L1+SD} of the pattern on the panel 2 is greater than or equal to 0.

As shown in FIG. 3, when the pattern on the panel 2 is relatively clear, the waveform of the brightness distribution of the pixels in the panel 2 becomes a gentle convex parabola having a relatively low peak. Accordingly, the standard deviation SD becomes relatively large. This increases the feature representing the clarity C_{L1, L1+SD} of the pattern on the panel 2. In this manner, when the clarity C_{L1, L1+SD} of the pattern on the panel 2 has a relatively large value, the pattern is relatively clear.

As shown in FIG. 4, when the pattern on the panel 2 is relatively unclear, the waveform of the brightness distribution of the pixels in the panel 2 becomes a steep parabola having a relatively high peak. Accordingly, the standard deviation SD becomes relatively small (SD′ shown in FIG. 4). This decreases the feature representing the clarity C_{L1, L1+SD} of the pattern on the panel 2. In this manner, when the clarity C_{L1, L1+SD} of the pattern on the panel 2 has a relatively small value, the pattern is relatively unclear. When the clarity C_{L1, L1+SD} of the pattern on the panel 2 is 0, the panel 2 has no pattern.

### Calculation of Clarity C_{L1, L2} of Display Subject 3

The feature calculator 16 obtains the clarity C_{L1, L2} of the display subject 3 by the following equation (3). Equation (3) uses the average brightness L₁ of the panel 2 and an average brightness L₂ (cd/m²) of the display subject 3.

$$Equation 3$$

$${C}_{L 1 , L 2} = \frac{{L}_{2} - {L}_{1}}{{L}_{1}} \qquad ( 3 )$$

As indicated above, the clarity C_{L1, L2} of the display subject 3 is a value indicating a brightness difference between a ratio of “L₂” to “L₁” and a ratio of “L₁” to “L₁”, that is, a ratio of “L₂-L₁” to “L₁” (brightness contrast). The clarity C_{L1, L2} of the display subject 3 is also referred to as, for example, the contrast ratio of the panel 2 and the display subject 3. When the clarity C_{L1, L2} of the display subject 3 is increased, the visual recognition of the display subject 3 is improved.

### Calculation of Mark Visual Angle α

As shown in FIG. 5, when obtaining the mark visual angle α, the feature calculator 16 uses a diameter φ (mm) of a smallest circle that fits the display subject 3, and a viewing distance d (mm) that corresponds to a physical distance between the display subject 3 and an eye point. In the present disclosure, an eye point refers to the location of an eye of a user. Then, the feature calculator 16 calculates the mark visual angle α by the following equation (4). As equation (4) indicates, when the diameter φ (size of display subject 3) is increased or when the viewing distance d is decreased, the mark visual angle α is increased. This improves the visual recognition of the display subject 3.

$$Equation 4$$

$$α = \frac{360}{π} {tan}^{- 1} ( \frac{ϕ}{2 d} ) \qquad ( 4 )$$

### Calculation of Chromaticity Difference D_{L1, L2}

As shown in FIG. 6, when obtaining the chromaticity difference D_{L1, L2}, the feature calculator 16 uses an average chromaticity (u′_{L1}, V′_{L1}) of the panel 2 and an average chromaticity (u′_{L2}, v′_{L2}) of the display subject 3. The average chromaticity (u′_{L1}, v′_{L1}) of the panel 2 indicates coordinates of an average chromaticity of the panel 2 expressed in accordance with the u′-v′ chromaticity. The average chromaticity (u′_{L2}, v′_{L2}) of the display subject 3 indicates coordinates of an average chromaticity of the display subject 3 expressed in accordance with the u′-v′ chromaticity. Then, the determination unit 17 calculates the chromaticity difference D_{L1, L2} by the following equation (5).

$$Equation 5$$

$${D}_{L 1 , L 2} = \sqrt{{( {{u}_{L 1}}^{′} - {{u}_{L 2}}^{′} )}^{2} + {( {{v}_{L 1}}^{′} - {{v}_{L 2}}^{′} )}^{2}} \qquad ( 5 )$$

The chromaticity difference D_{L1, L2} corresponds to a linear distance between the above coordinates on the u′-v′ chromaticity. As the chromaticity difference D_{L1, L2} increases, the visual recognition of the display subject 3 improves.

### Operation of Visual Recognition Determination

As shown in FIG. 7, the determination unit 17 determines the visual recognition of the display subject 3 based on the features calculated by the feature calculator 16. In an example, the feature calculator 16 uses the above-described equations (2) to (5) to obtain the clarity C_{L1, L1+SD} of the pattern on the panel 2, the clarity C_{L1, L2} of the display subject 3, the mark visual angle α, and the chromaticity difference D_{L1, L2}. Then, the determination unit 17 substitutes these features into the determination equation (1) to calculate the determination value p for determining the visual recognition of the display subject 3.

In this case, the determination unit 17 compares the calculated determination value p with a specified value to determine the appropriateness of the visual recognition of the display subject 3. More specifically, when the determination value p is greater than or equal to the specified value, the determination unit 17 determines that the visual recognition of the display subject 3 is satisfactory. When the determination value p is less than the specified value, the determination unit 17 determines that the visual recognition of the display subject 3 is poor. Subsequently, the determination unit 17 displays the determination result of the appropriateness of the visual recognition on, for example, a display unit (not shown) of the visual recognition determination system 13 to notify an operator of the result.

When the visual recognition of the display subject 3 is poor, the operator changes an illumination pattern of the display subject 3 by adjusting the design elements related to the visual recognition of the display subject 3. This process is repeated to optimize the visual recognition of the display subject 3. In the present example, the determination result of the visual recognition is output in a binary pattern of “satisfactory” or “poor”. Thus, the operator may easily determine the appropriateness of the visual recognition of the display subject 3.

### Advantages of First Embodiment

The visual recognition determination system 13 (visual recognition determination method, program) of the above embodiment has the following advantages.

(1-1) The light source 10 emits light onto the back surface of the panel 2, in which the display subject 3 is formed, to show the display subject 3 on the pattern on the panel 2, serving as the background, with the light transmitted through the display subject 3. In this case, the visual recognition determination system 13 determines the visual recognition of the display subject 3. More specifically, the visual recognition determination system 13 includes the determination unit 17 that determines the visual recognition of the display subject 3 based on the feature representing the clarity C_{L1, L1+SD} of the pattern on the panel 2.

With this configuration, the visual recognition of the display subject 3 is determined using an index of the feature representing the clarity C_{L1, L1+SD} of the pattern on the panel 2. This allows for an accurate determination of the manner in which the display subject 3 appears in contrast to the pattern on the panel 2. In other words, whether the display subject 3 is easily recognized on the patterned background may be determined. Thus, the visual recognition of the display subject 3 is accurately determined.

(1-2) The feature representing the clarity C_{L1, L1+SD} of the pattern on the panel 2 is obtained from the average brightness L₁ of the panel 2 and the standard deviation SD of the brightness of the panel 2. With this configuration, the clarity C_{L1, L1+SD} of the pattern on the panel 2 is readily obtained from the average brightness L₁ of the panel 2 and the standard deviation SD of the brightness of the panel 2.

(1-3) The determination unit 17 determines the visual recognition of the display subject 3 using, in addition to the clarity C_{L1, L1+SD} of the pattern on the panel 2, at least one of the clarity C_{L1, L2} of the display subject 3, the mark visual angle α representing the size of the display subject 3, and the chromaticity difference D_{L1, L2} between the panel 2 and the display subject 3. With this configuration, the visual recognition of the display subject 3 is determined using multiple indicators. This further contributes to obtaining an optimal determination result.

(1-4) The determination unit 17 determines the visual recognition of the display subject 3 at an actual attachment counterpart of the display device 1 that shows the display subject 3 on the panel 2. With this configuration, the visual recognition of the display subject 3 is determined under the environment of the attachment counterpart, to which the display device 1 is to be actually attached. This allows for setting of an optimal visual recognition of the display subject 3 in accordance with the environment of the attachment counterpart.

(1-5) The determination unit 17 substitutes the feature representing the clarity C_{L1, L1+SD} of the pattern on the panel 2 (features representing C_{L1, L2}, α, and D_{L1, L2} are also included in the present example) into the determination equation (1) for determining the visual recognition of the display subject 3 to obtain the determination value p, and determines the visual recognition of the display subject 3 based on the determination value p. With this configuration, the manner in which the display subject 3 appears may be determined through a simple process of substituting the feature into the determination equation (1) and determining the visual recognition with the obtained determination value p.

(1-6) The determination equation (1) is an equation that uses logistic regression analysis for predicting whether the visual recognition will be satisfactory through regression analysis of multiple explanatory variables. With this configuration, the visual recognition may be determined by comparing values to decide whether the determination value p satisfies the specified value. This simplifies the determination process of the visual recognition.

### Second Embodiment

A second embodiment will now be described. The second embodiment is an example in which the first embodiment is provided with an additional function. Therefore, same reference numerals are given to those components that are the same as the corresponding components of the first embodiment. The description will focus on the differences from the first embodiment.

### Overview of Automatic Adjustment of Visual Recognition of Display Subject 3

As shown in FIG. 8, the visual recognition determination system 13 includes a function (feedback function) that automatically adjusts the light source 10 in accordance with a determination result of the determination unit 17. In this case, the visual recognition determination system 13 includes an adjustment unit 21 that adjusts the operation of the light source 10 in accordance with a determination result of the determination unit 17. The adjustment unit 21 controls the light source 10 in accordance with the determination result of the determination unit 17 so that the visual recognition of the display subject 3 is improved.

### Automatic Adjustment of Visual Recognition of Display Subject 3

In the present example, the adjustment unit 21 obtains the determination value p from the determination unit 17 as the determination result of the visual recognition. When the determination value p is less than the specified value, the adjustment unit 21 adjusts the light source 10. Specifically, the adjustment unit 21 adjusts the illumination pattern of the light source 10 by changing, for example, an output brightness of the light source 10, the number of illuminated light sources 10, the color of the light source 10, a combination of the above, or the like. The adjustment unit 21 repeats this series of adjustment until the determination value p becomes greater than or equal to the given value. This automatically optimizes the visual recognition of the display subject 3.

### Advantages of Second Embodiment

The visual recognition determination system 13 (visual recognition determination method, program) of the above embodiment has the following advantages.

(2-1) The adjustment unit 21 of the visual recognition determination system 13 adjusts the operational state of the light source 10 in accordance with the determination result of the determination unit 17 so that the visual recognition of the display subject 3 is improved. With this configuration, the adjustment unit 21 automatically adjusts the visual recognition of the display subject 3 to an optimal state.

### Third Embodiment

A third embodiment will now be described. The description of the third embodiment will also focus on the differences from the first and second embodiments.

### Configuration of Optical Simulator 30

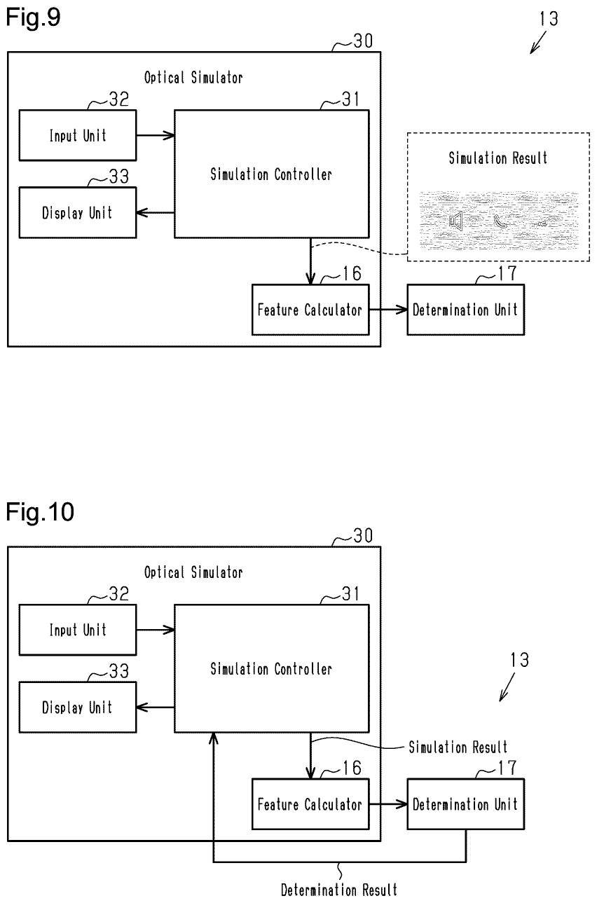

As shown in FIG. 9, an optical simulator 30 illuminates the display subject 3 in a virtual space. The optical simulator 30 includes, for example, a simulation controller 31, an input unit 32, and a display unit 33. The input unit 32 is used when inputting a simulation condition. Examples of the simulation condition include the state of ambient light, material light reflection characteristics, human eye characteristics, or the like. The state of ambient light is set by, for example, specifying one of outdoor, indoor, inside tunnel, or the like. The material light reflection characteristics are set by, for example, inputting the light reflection characteristic of the material of a member on which the display subject 3 is shown. The human eye characteristics are set by, for example, inputting an eye color, color vision characteristics, or the like.

The simulation controller 31 executes a simulation process in accordance with the simulation condition input by the input unit 32. The simulation process is, for example, a process that simulates in a virtual space the manner in which the display subject 3 will be shown when the display subject 3 is illuminated under the simulation condition. The display unit 33 shows, for example, various screens produced by the simulation process.

### Overview of Visual Recognition Determination System 13

As shown in FIG. 9, the feature calculator 16 is arranged in the optical simulator 30. In the present example, the feature calculator 16 calculates a feature used for determining the visual recognition from a simulation result obtained by the simulation controller 31. Specifically, the feature calculator 16 calculates the features representing C_{L1, L1+SD}, C_{L1, L2}, α, and D_{L1, L2} from the simulation result. In the present example, the feature calculator 16 obtains these features by, for example, reading numerical values from the simulation result.

The determination unit 17 determines the visual recognition of the display subject 3 based on the features obtained by the feature calculator 16. In this manner, the determination unit 17 of the present example uses the optical simulator 30 to determine the visual recognition of the display subject 3. In the present example, the determination unit 17 also uses the determination equation (1) to obtain the determination value p, and determines the appropriateness of the visual recognition of the display subject 3 based on the determination value p.

### Operation of Visual Recognition Determination

When determining the visual recognition of the display subject 3 using the optical simulator 30, first, the simulation condition is set for showing the display subject 3 in a virtual space. Specifically, an operator sets the state of ambient light, the material light reflection characteristics, the human eye characteristics, or the like in the optical simulator 30.

As a simulation initiating operation is performed after the simulation condition is set, the simulation controller 31 simulates in an optical simulation space a state in which the display subject 3 is illuminated in accordance with the set simulation condition. If multiple display subjects 3 are present in the simulation space, each of the display subjects 3 is simulated. Then, the simulation controller 31 outputs the obtained simulation result to the feature calculator 16.

The simulation result may be shown, for example, on the display unit 33 of the optical simulator 30. In this case, the display unit 33 shows, for example, the manner in which the illuminated display subject 3 appears. Thus, an image of the display subject 3 shown on the display unit 33 allows for visual recognition of, for example, the size, brightness (clarity), intensity, chromaticity difference, or the like of the simulated display subject 3.

The feature calculator 16 calculates a feature used for determining the visual recognition of the display subject 3 based on the simulation result obtained from the simulation controller 31. Specifically, the feature calculator 16 detects the features representing C_{L1, L1+SD}, C_{L1, L2}, α, and D_{L1, L2}. The feature calculator 16 outputs the obtained features to the determination unit 17.

The determination unit 17 determines the visual recognition of the display subject 3 based on the features received from the feature calculator 16. The determination unit 17 of the present example substitutes the features into the above-described determination equation (1) to obtain the determination value p, and determines the appropriateness of the visual recognition from the determination value p. If multiple display subjects 3 are present in the simulation space, the visual recognition of each of the display subjects 3 is determined. In the present example, the determination unit 17 also determines that the visual recognition is appropriate when the determination value p is greater than or equal to a specified value.

As shown in FIG. 10, the optical simulator 30 may visually notify an operator of the determination result of the determination unit 17. More specifically, the simulation controller 31 obtains the determination result from the determination unit 17 and displays the determination result on the display unit 33 in an image that can be seen by the operator.

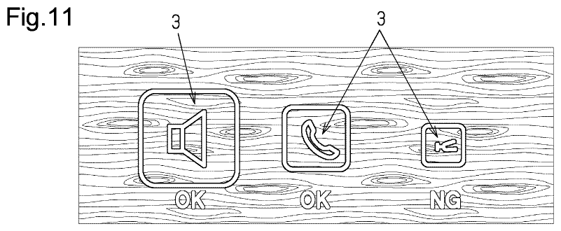

FIG. 11 shows a notification example of a determination result of the visual recognition determination. The simulation controller 31 displays a determination result of the visual recognition of the display subject 3 using, for example, characters, graphics, colors, or the like. When the visual recognition of the display subject 3 is appropriate, for example, characters “OK” may be shown, or the characters or a relatively large shape surrounding the characters may be shown in green. On the other hand, when the visual recognition of the display subject 3 is not appropriate, for example, characters “NG” may be shown, or the characters or a relatively small shape surrounding the characters may be shown in red.

### Advantage of Third Embodiment

The visual recognition determination system 13 (visual recognition determination method, program) of the above embodiment has the following advantages.

(3-1) The determination unit 17 determines the visual recognition of the display subject 3 using the optical simulator 30 that illuminates the display subject 3 in a virtual space. With this configuration, the visual recognition of the display subject 3 may be determined under the environment of optical simulation. Thus, the visual recognition of the display subject 3 may be checked without actually manufacturing the display device 1.

### OTHER EMBODIMENTS

The above embodiments may be modified as follows. The above embodiments and the following modifications can be combined as long as they remain technically consistent with each other.

In each embodiment, the image acquisition unit 15 and the feature calculator 16 are included in the visual recognition determination system 13. However, these components may be separate from the visual recognition determination system 13. In this case, the determination unit 16 may obtain the features described in the above embodiments (e.g., feature representing clarity C_{L1, L1+SD} of pattern on panel 2) from the feature calculator 16 that is separated from the visual recognition determination system 13. Alternatively, only the feature calculator 16 of the image acquisition unit 15 and the feature calculator 16 may be included in the visual recognition determination system 13.

In the first embodiment (FIG. 7) and the second embodiment (FIG. 8), the feature calculator 16 is included in the image acquisition unit 15. However, the feature calculator 16 may be separate from the image acquisition unit 15. For example, the determination unit 17 may include the feature calculator 16 (or function thereof), and obtain features from an image captured by the image acquisition unit 15.

In each embodiment, only the clarity C_{L1, L1+SD} of the pattern on the panel 2 may be used as the feature for determining the visual recognition of the display subject 3. In other words, the clarity C_{L1, L2} of the display subject 3, the mark visual angle α, and the chromaticity difference D_{L1, L2} between the panel 2 and the display subject 3 do not necessarily have to be used as additional features.

In each embodiment, the determination unit 17 does not have to use the determination equation (1) to determine the visual recognition of the display subject 3. The determination equation (1) is an example of a determination equation when the clarity C_{L1, L1+SD} of the pattern on the panel 2, the clarity C_{L1, L2} of the display subject 3, the mark visual angle α, and the chromaticity difference D_{L1, L2} between the panel 2 and the display subject 3 are all used. For example, the visual recognition of the display subject 3 may be determined by comparing the features with their respective specified value.

In each embodiment, the pattern on the panel 2 does not have to be wood-grain-like, and may be, for example, striped, checked, geometric, textile, tile, brick, stone, floral, plant, or the like.

In each embodiment, the layer structure of the panel 2 may be changed to a structure other than that of the embodiment.

In each embodiment, the panel 2 may include a switch that is paired with the display subject 3.

In each embodiment, the display subject 3 may have a functionality of a touch switch. Specifically, a sensor (e.g., sensor sheet) may be arranged on the back surface of the display subject 3 in the panel 2 to detect a touch operation performed on the display subject 3.

In each embodiment, multiple display subjects 3 may be shown on the panel 2.

In each embodiment, the determination equation (1) is not limited to an equation that uses logistic regression analysis. For example, other types of equation that uses multiple regression analysis may be used.

In each embodiment, the visual recognition determination system 13 may be a permanent system installed in a vehicle or a mobile system that can be carried. In the case of a permanent system, the visual recognition may be determined constantly. In the case of a mobile system, a single system can be shared by multiple vehicles.

In each embodiment, the visual recognition determination system 13 does not have to installed in a vehicle. Instead, the visual recognition determination system 13 may be used with other devices or apparatuses.

In each embodiment, the phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of two or more choices” if the number of its choices three or more.

In each embodiment, the feature calculator 16, the determination unit 17, and the adjustment unit 21 may each be formed by (1) one or more processors that run a computer program (software) or (2) a combination of such processors and one or more dedicated hardware circuits, such as an application specific integrated circuit (ASIC) that executes at least part of various types of processes. The processor includes a central processing unit (CPU) and a memory, such as a random-access memory (RAM) or a read-only memory (ROM). The memory stores program codes or commands configured to cause the CPU execute processes. The memory (computer readable medium) may be any available medium accessible by a versatile or dedicated computer. Alternatively, instead of a computer including the above-described processor, there may be processing circuitry formed by one or more dedicated hardware circuits that execute all of various types of processes.

In each embodiment, the feature calculator 16, the determination unit 17, and the adjustment unit 21 may be formed by separate processors. Alternatively, the functionalities of the feature calculator 16, the determination unit 17, and the adjustment unit 21 may be partially shared by a common processor. In this manner, the feature calculator 16, the determination unit 17, and the adjustment unit 21 do not have to be formed by separate functional blocks, and may be formed by the same functional block or by partially shared functional blocks.

Various changes in form and details may be made to the examples above without departing from the spirit and scope of the claims and their equivalents. The examples are for the sake of description only, and not for purposes of limitation. The present disclosure includes various modified examples and modifications within the scope of equivalence. Additionally, various combinations and modes and one, more, or less of these elements in other combinations and forms are included in the range and conceptual scope of the present disclosure.

1. A visual recognition determination system configured to determine visual recognition of a display subject when light is emitted from a light source onto a back surface of a panel, in which the display subject is formed, and the light transmitted through the display subject shows the display subject on a pattern on the panel, the pattern serving as a background of the display subject, the visual recognition determination system comprising:
a determination unit that determines the visual recognition of the display subject based on a feature representing a clarity of the pattern on the panel.

2. The visual recognition determination system according to claim 1, wherein the feature representing the clarity of the pattern on the panel is obtained from an average brightness of the panel and a standard deviation of the brightness of the panel.

3. The visual recognition determination system according to claim 1, wherein the determination unit determines the visual recognition of the display subject using, in addition to the clarity of the pattern on the panel, at least one of a clarity of the display subject, a mark visual angle representing a size of the display subject, and a chromaticity difference between the panel and the display subject.

4. The visual recognition determination system according to claim 1, further comprising:
an adjustment unit that adjusts an operational state of the light source in accordance with a determination result of the determination unit so that the visual recognition of the display subject is improved.

5. The visual recognition determination system according to claim 1, wherein the determination unit determines the visual recognition of the display subject at an actual attachment counterpart of the display device that shows the display subject on the panel.

6. The visual recognition determination system according to claim 1, wherein the determination unit determines the visual recognition of the display subject using an optical simulator that illuminates the display subject in a virtual space.

7. The visual recognition determination system according to claim 1, wherein:
the determination unit substitutes the feature representing the clarity of the pattern on the panel into a determination equation, the determination equation being used for determining the visual recognition of the display device, to obtain a determination value; and
the determination unit determines the visual recognition of the display subject based on the determination value.

8. The visual recognition determination system according to claim 7, wherein the determination equation is an equation that uses logistic regression analysis for predicting whether the visual recognition will be satisfactory through regression analysis of multiple explanatory variables.

9. A method for determining visual recognition used in a visual recognition determination system configured to determine visual recognition of a display subject when light is emitted from a light source onto a back surface of a panel, in which the display subject is formed, and the light transmitted through the display subject shows the display subject on a pattern on the panel, the pattern serving as a background of the display subject, the method comprising:
obtaining, by the visual recognition determination system, a feature that represents a clarity of a pattern on the panel; and
determining, by the visual recognition determination system, the visual recognition of the display based on the feature representing the clarity of the pattern on the panel.

10. A non-transitory computer readable storage medium storing instructions that, when executed by a computer in a visual recognition determination system, cause the computer to perform operations, the visual recognition determination system configured to determine visual recognition of a display subject when light is emitted from a light source onto a back surface of a panel, in which the display subject is formed, and the light transmitted through the display subject shows the display subject on a pattern on the panel, the pattern serving as a background of the display subject, the operations comprising:
obtaining a feature that represents a clarity of a pattern on the panel; and
determining the visual recognition of the display based on the feature representing the clarity of the pattern on the panel.
